(19) United States
(12) Patent Application Publication
(10) Pub. No.: US 2019/0092415 A1
(43) Pub. Date: Mar. 28, 2019

(54) MOTORCYCLE FRAME SUPPORT BRACKET

(71) Applicant: Zane Campbell, Lexington Park, MD (US)

(72) Inventor: Zane Campbell, Lexington Park, MD (US)

(21) Appl. No.: 16/142,697

(22) Filed: Sep. 26, 2018

Related U.S. Application Data
(63) Continuation-in-part of application No. 29/619,284, filed on Sep. 28, 2017.
(60) Provisional application No. 62/564,057, filed on Sep. 27, 2017.

(51) Int. Cl. B62K 19/30; B62J 25/00

(52) U.S. Cl. CPC B62K 19/30; B62J 25/00

(57) ABSTRACT

A motorcycle frame support bracket for a frame of a motorcycle. The motorcycle frame support bracket includes a plate having a first portion, a second portion, and an angled portion, wherein the angled portion extends upwardly from the second portion, such that the first portion is positioned at an offset above the second portion. The first portion includes a pair of apertures disposed on opposing ends thereof, wherein each aperture receives a fastener therethrough. The second portion includes a protrusion extending perpendicularly away from the plate in a same direction as the angled portion, wherein the protrusion includes a channel extending therethrough, wherein the channel receives a fastener. Each of the first portion and the second portion of the plate removably secure to a frame of a motorcycle, such that a surface of each of the first portion and the second portion rests flush against a surface of the frame.

### CROSS REFERENCE TO RELATED APPLICATION

This application claims the benefit of U.S. Provisional Application No. 62/564,057 filed on Sep. 27, 2017 and U.S. Design Application No. 29/619,284 filed on Sep. 28, 2017. The above identified patent application is herein incorporated by reference in its entirety to provide continuity of disclosure.

### BACKGROUND OF THE INVENTION

The present invention relates to support brackets for motorcycles. More specifically, the present invention provides a motorcycle frame support bracket that attaches to a trestle frame of a motorcycle to increase the strength of various weak points on the trestle frame foot control mounting locations.

Most motorcycles include a frame that has various systems of the motorcycle attach to it, such as the engine, foot controls, and exhaust system. These systems typically attach to the frame using various types of brackets and bolts to secure thereto. If a weak bracket is used, these systems can detach during a crash and further damage the frame of the motorcycle. In such a situation, the bracket may fail due to weak points associated with the mounting locations on the frame.

Over the years there have been many variations of motorcycle frame support brackets. The most common support bracket typically includes a single flat piece of metal. These types of brackets are typically thin metal sheets, that attach to the frame at various mounting locations. Because of the lack of thickness, these brackets typically fail during a crash. Many times, this failure results in damage to the frame of the motorcycle. Further, some brackets lacked curved edges and offset mounting locations that can strategically position the bracket around integral parts of the motorcycle frame. Therefore, a new motorcycle frame support bracket that secures to and around integral portions of a motorcycle frame is needed.

Devices have been disclosed in the known art that relate to support brackets for motorcycles. These include devices that have been patented and published in patent application publications. These devices generally relate to brackets that include a plate having at least one securing means for removably securing the plate to a motorcycle, including a removably securable protrusion extending away from the motorcycle when the plate is attached. Additionally, many of these devices include a bracket configured to removably secure a foot support member thereto. However, these devices fail to disclose a plate having a first portion offset from the second portion, wherein the second portion comprises an integral protrusion wherein the protrusion is configured to insert into a motorcycle frame to removably secure the plate thereto.

In light of the devices disclosed in the known art, it is submitted that the present invention substantially diverges in design elements from the known art and consequently it is clear that there is a need in the art for an improvement to existing support bracket devices. In this regard the instant invention substantially fulfills these needs.

### SUMMARY OF THE INVENTION

In view of the foregoing disadvantages inherent in the known types of support brackets now present in the known art, the present invention provides a new motorcycle frame support bracket wherein the same can be utilized for providing convenience for the user when securing the support bracket to a trestle frame of a motorcycle to increase the strength of various weak points on the trestle frame foot control mounting locations.

It is therefore an object of the present invention to provide a new and improved motorcycle frame support bracket that has all of the advantages of the prior art and none of the disadvantages.

Another object of the present invention is to provide a motorcycle frame support bracket including a plate having a first portion, a second portion, and an angled portion, wherein the angled portion extends upwardly from the second portion, such that the first portion is positioned at an offset above the second portion. The first portion includes a pair of apertures disposed on opposing ends thereof, wherein each aperture receives a fastener therethrough. The second portion includes a protrusion extending perpendicularly away from the plate in a same direction as the angled portion, wherein the protrusion includes a channel extending therethrough, wherein the channel receives a fastener. Each of the first portion and the second portion of the plate removably secure to a frame of a motorcycle, such that a surface of each of the first portion and the second portion rests flush against a surface of the frame. A foot support member can be removably secured to the plate at the pair of apertures, wherein the foot support member receives a foot of a user thereon. The support bracket further comprises a thickness configured to provide structural stability to the frame.

Another object of the present invention is to provide a motorcycle frame support bracket that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particular pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the motorcycle frame support bracket.

FIG. 2 shows a side view of an embodiment of the motorcycle frame support bracket.

FIG. 3 shows a top view of an embodiment of the motorcycle frame support bracket.

FIG. 4 shows a perspective view of an embodiment of the motorcycle frame support bracket, wherein the bracket is secured to a motorcycle frame.

### DETAILED DESCRIPTION OF THE INVENTION

Reference is made herein to the attached drawings. Like reference numerals are used throughout the drawings to depict like or similar elements of the motorcycle frame support bracket. For the purposes of presenting a brief and clear description of the present invention, the preferred embodiment will be discussed as used for attaching to a trestle frame of a Ducati motorcycle to increase the strength of various weak points on the trestle frame foot control mounting locations. However, alternative embodiments of the motorcycle frame support bracket may be configured for use on various types of motorcycle frames. The figures are intended for representative purposes only and should not be considered to be limiting in any respect.

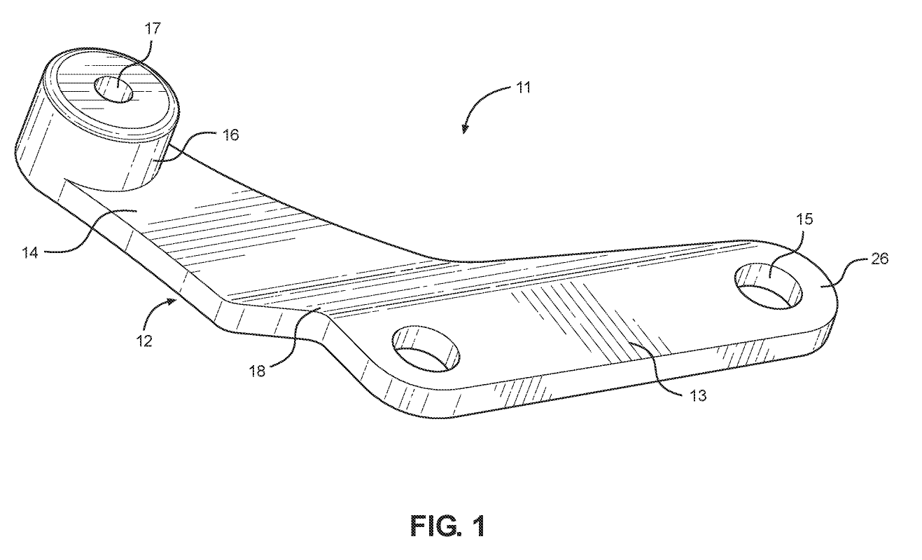

Referring now to FIG. 1, there is shown a perspective view of an embodiment of the motorcycle frame support bracket. The motorcycle frame support bracket 11 includes a plate 12 having a first portion 13, a second portion 14, and an angled portion 18, wherein the angled portion 18 extends upwardly from the second portion 14. The angled portion 18 positions the first portion 13 at an offset above the second portion 14, wherein a plane of the first portion 13 is in parallel with a plane of the second portion 14. In the illustrated embodiment, the plate 12 comprises a substantially triangular shape. However, in alternative embodiments, the plate 12 may be any suitable shape.

The first portion 13 includes a pair of apertures 15 disposed on opposing ends 26 thereof, wherein each aperture of the pair of apertures 15 is configured to receive a fastener therethrough, such that the first portion 13 removably secures to a frame of a motorcycle. The second portion 14 includes a protrusion 16 extending perpendicularly away from the plate 12 in a same direction as the angled portion 18. The protrusion 16 includes a channel 17 extending therethrough, wherein the channel 17 is configured to receive a fastener. The protrusion 16 is configured to rest within an opening on the frame of a motorcycle, such that the protrusion can be removably secured thereto via a fastener inserted through the channel 17. In this way, each of the first portion 13 and the second portion 14 are configured to removably secure to a frame of a motorcycle, such that a surface the plate 12 rests flush against a surface of the motorcycle frame when secured thereto. Further, the motorcycle frame support bracket 11 is configured to receive a foot support member, wherein the foot support member can be removably secured to the first portion 13 of the bracket 11 at the pair of apertures 15. The foot support member is configured to receive a foot of the user thereon.

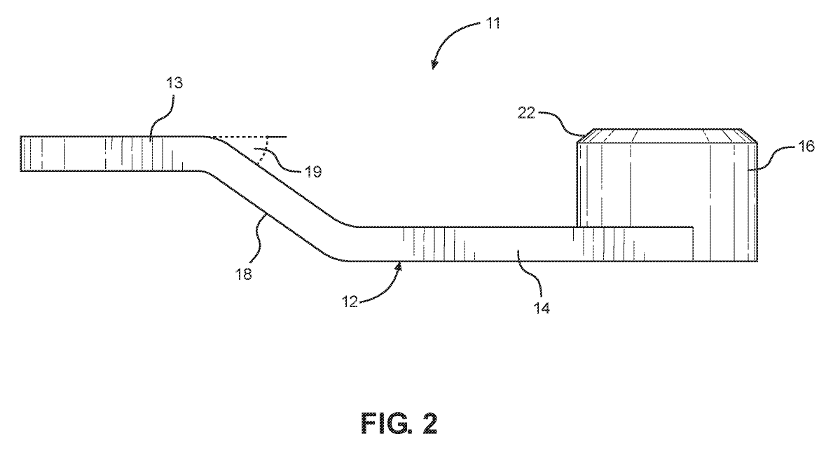

Referring now to FIG. 2, there is shown a side view of an embodiment of the motorcycle frame support bracket. In the illustrated embodiment, the angled portion 18 of the plate 12 is disposed at an angle 19 in relation to the plane of the first portion 13. The angled portion 18 positions the plane of the second portion 14 of the plate 12 below the plane of the first portion 13. In the illustrated embodiment, the angle is a 33.7 degree angle. However, in alternative embodiments the angle can be any suitable degree. Further the angled portion 18 provides an offset for both the first portion 13 and second portion 14, such that a top surface of each of the first portion 13 and the protrusion 16 of the second portion 14 rest in the same plane. The offset allows the support bracket 11 to fit around integral parts of the motorcycle frame when attached thereto.

In the illustrated embodiment, the protrusion 16 further includes a beveled edge 22 on the distal end thereof. The beveled edge 22 is configured to fit flush within the opening on the frame, thereby providing a tight fit to prevent any movement of the support bracket 11 when attached to the frame. The support bracket 11 is constructed of a durable material, such as steel, to provide structural stability to the frame. However, alternative materials, such as aluminum or metal alloy may be used.

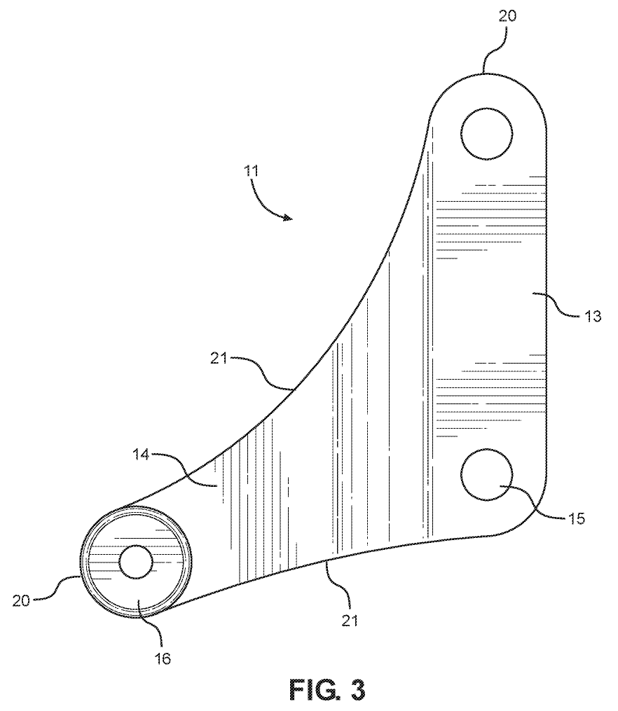

Referring now to FIG. 3, there is shown a top view of an embodiment of the motorcycle frame support bracket. In the illustrated embodiment, the motorcycle frame support bracket 11 is substantially triangular and includes rounded corners 20 on both the first portion 13 and the second portion 14. The support bracket 11 further includes two opposing arcuate edges 21 disposed along lateral sides of the plate between the protrusion 16 of the second portion 14 and each of the pair of apertures 15 on the first portion 13. The arcuate edges 21 curve inwardly towards a center of the support bracket 11. The arc of each of the arcuate edges 21 is configured to position the support bracket 11 such that the bracket 11 does not contact integral portions of the motorcycle frame. The support bracket 11 tapers from the first portion 13 to the second portion 14, such that the protrusion 16 is substantially aligned with one of the pair of apertures 15.

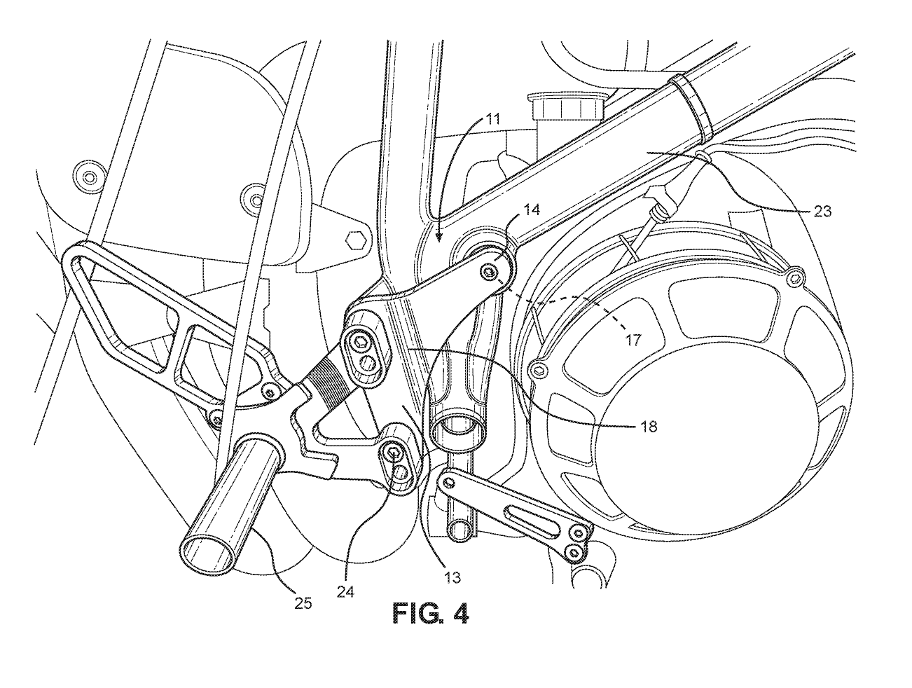

Referring now to FIG. 4, there is a shown a perspective view of an embodiment of the motorcycle frame support bracket, wherein the bracket is secured to a motorcycle frame. When in an attached position, the motorcycle frame support bracket 11 is removably securable to a motorcycle frame 23 via a plurality of fasteners 24. In the illustrated embodiment, the plurality of fasteners 24 are configured as blots. The protrusion of the second portion 14 removably secures within an opening disposed on the motorcycle frame 23 via a bolt. In the illustrated embodiment, the channel 17 of the protrusion extending from the plate, further includes a recessed lip on a bottom end thereof. The lip is configured to receive a bolt head, such that when attached to the frame 23 of a motorcycle the bolt head rests flush with the bottom surface of the second portion 14. This prevents the bolt head from contacting a user while the motorcycle is in operation.

In the illustrated embodiment, the first portion 13 is stacked between the foot support member 25 and the frame 23, wherein each removably secures to one another via a plurality of fasteners 24 that are received through the pair of apertures disposed on the first portion 13. When attached, the angled portion 18 of the motorcycle frame support bracket 11 allows the bracket to fit flush around the exterior surface of the motorcycle frame 23. The motorcycle frame support bracket 11 provides structural stability to the frame while strengthening various weak points for the foot support member 25 mounting locations.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A motorcycle frame support bracket, comprising:
a plate having a first portion, a second portion, and an angled portion, wherein the angled extends upwardly from the second portion, such that the first portion is positioned at an offset above the second portion, wherein a plane of the first portion is in parallel with a plane of the second portion;
wherein the first portion includes a pair of apertures disposed on opposing ends thereof, wherein each aperture of the pair of apertures is configured to receive a fastener therethrough;
wherein the second portion includes a protrusion extending perpendicularly away from the plate in a same direction as the angled portion, wherein the protrusion includes a channel extending therethrough, wherein the channel is configured to receive a fastener;
wherein each of the first portion and the second portion are configured to removably secure to a frame of a motorcycle, such that a surface of each of the first portion and the second portion rests flush against a surface of the frame.

2) The motorcycle frame support bracket of claim 1, wherein the plate comprises a triangular shape.

3) The motorcycle frame support bracket of claim 1, wherein the protrusion includes a beveled edge on a distal end thereof.

4) The motorcycle frame support bracket of claim 1, wherein the angled portion of the plate is disposed at an angle in relation to the plane of the first portion.

5) The motorcycle frame support bracket of claim 4, wherein the angle is 33.7 degrees.

6) The motorcycle frame support bracket of claim 1, wherein the plate includes rounded corners.

7) The motorcycle frame support bracket of claim 1, wherein the plate further includes two opposing arcuate edges disposed along lateral sides thereof, wherein the opposing arcuate edges are positioned between the protrusion of the second portion and each of the pair of apertures of the first portion, wherein a curve of each of the arcuate edges arcs inwardly toward a center of the plate.

8) The motorcycle frame support bracket of claim 1, wherein the channel of the protrusion includes a recessed lip configured to receive a bolt head, such that when attached to a frame the bolt head rests flush with a bottom surface of the protrusion.

9) The motorcycle frame support bracket of claim 1, wherein the plate is constructed of steel.

10) The motorcycle frame support bracket of claim 1, wherein the plate is constructed of aluminum.
